(19) United States
(12) Patent Application Publication
(10) Pub. No.: US 2014/0321235 A1
(43) Pub. Date: Oct. 30, 2014

(54) ACOUSTIC SONAR IMAGING AND DETECTION SYSTEM FOR FIREFIGHTING APPLICATIONS

(71) Applicants: Ofodike A. Ezekoye, Austin, TX (US); Mustafa Z. Abbasi, Austin, TX (US); Preston Wilson, Austin, TX (US)

(72) Inventors: Ofodike A. Ezekoye, Austin, TX (US); Mustafa Z. Abbasi, Austin, TX (US); Preston Wilson, Austin, TX (US)

(21) Appl. No.: 14/258,624

(22) Filed: Apr. 22, 2014

Related U.S. Application Data
(60) Provisional application No. 61/815,472, filed on Apr. 24, 2013.

(51) Int. Cl. G01S 7/56; G01S 15/89

(52) U.S. Cl. CPC G01S 7/56; G01S 15/89
USPC 367/11; 367/7

(57) ABSTRACT

Techniques for navigating a high temperature low visibility environment are supported. A system may employ appropriate sonar signals to determine and display the location or distance to remote structures that may be obscured in the high temperature low visibility environment. Firefighters, military personnel, and other individuals that must navigate through obscured, high temperature environments may interact with suitable devices, such as a handheld device, to access and display the approximate location or distance of the remote structures or pathways. These devices may facilitate effective navigation of high temperature low visibility environments, thereby minimizing the risk of traumatic or fatal bodily injuries posed by the dangerous conditions.

### RELATED APPLICATIONS

This application claims the benefit of priority of U.S. Provisional Patent Application No. 61/815,472 filed on Apr. 24, 2013.

### TECHNICAL FIELD

The present disclosure relates generally to acoustic sonar imaging systems, and more specifically to acoustic sonar imaging systems for obscured, high temperature environments.

### BACKGROUND

Many individuals must navigate through obscured, high temperature environments. For example, fire fighters may need to navigate a fire ground, or military personnel may need to navigate a battlefield. In those situations, active flames, and aerosol particles such as smoke, dust, vapors or other airborne particles can reduce visibility, and thereby limit navigation in those environments in a safe and efficient manner. Specialized equipment may facilitate navigating such obscured, high temperature environments characterized by low visibility and involving high risk of traumatic bodily injury or life.

### SUMMARY

In accordance with the present disclosure, a navigation method and system for navigating obscured, high temperature environments characterized by low visibility is provided which substantially eliminates or reduces disadvantages and problems associated with previous systems and methods.

According to a particular embodiment, a handheld navigation apparatus is provided, which includes a display, a memory for maintaining a sonar processing application, a transmitter capable of transmitting low frequency sonar signals, an array of sensors capable of detecting low frequency sonar signals, and a processor capable of executing the sonar processing application to implement various features. In particular, the sonar processing application can be executed to transmit, using the transmitter, a frequency modulated sonar signal of long duration toward a remote object located in the obscured high temperature environment and receive, using an array of sensors, spatially diverse reflections of the frequency modulated sonar signal. In addition, the sonar processing application can calculate a cross correlation of the received reflections of the frequency modulated sonar signal to the transmitted frequency modulated sonar signal, determine the approximate distance of the remote object located in the obscured high temperature environment based on the calculated cross correlation, and display an image on the display depicting the approximate distance of the remote object.

Particular embodiments may overcome limitations of existing navigation tools. For example, information gathered by systems and methods of the present disclosure may be resistant to heat and open flames that may significantly degrade thermal imaging camera performance. Thus, some embodiments may enable users to detect remote objects through an actively burning fire. In addition, some embodiments may facilitate differentiating structures that may appear similar on a thermal imaging camera system because they have approximately the same temperature as the background or other co-located structures. Moreover, certain embodiments of the present disclosure may facilitate penetrating the turbulent structure of the fire that may cause distortion in certain types of signals. Thus, the teachings of the present disclosure may be employed to provide visualization in a wider range of obscured, high temperature conditions and facilitate navigation in those dangerous environments by enhancing spatial perception.

Some embodiments may be used to help firefighters navigate a burning building either as a standalone sonar system or combined with a thermal imaging camera system. Particular embodiments may also use sonar signals to obtain an image of the active fire itself. Thus, a thermal imaging camera system may be complemented with teachings of the present disclosure to enhance a user's awareness of structures and dangerous elements in a high temperature low visibility environment. Other embodiments may include suitable environmental and/or atmospheric sensors (e.g., thermometers, bolometers, barometers, and/or water vapor sensors) in order to determine the evolution of the obscured, high temperature environment over time. Such embodiments may facilitate higher resolution distance calculations based on adjustments to the speed of sound given varying environmental conditions. Certain embodiments may be employed in mobile platforms, such as mobile search and rescue robots used to assist fire fighters. Particular embodiments may be used by military personnel to visualize and determine distances of remote objects in the field using appropriate sonar signals to characterize environments obscured by fire, smoke, dust, fog, or other particles that may diminish visibility. Particular embodiments may use suitable sensors of position or movement, such as accelerometers and/or gyroscopes, to measure, calculate, store, and display information regarding position, speed, orientation, angle, or other appropriate information. For example, the teachings of the present disclosure may be combined with systems capable of determining positions in a three-dimensional space, angle of orientation, heading, elevation, and bank (e.g., yaw, pitch, and/or roll). Such additional information may enable a suitable system to provide a user with a comprehensive image of an obscured, high temperature environment as it may change over time and in relation to movement of the system or the user. This additional information may also facilitate determining the location of the flame of an active fire with higher resolution, and further determine how the flame changes over time.

Other embodiments may be employed in mobile platforms, such as mobile search and rescue robots used to assist fire fighters. Particular embodiments may be used by military personnel to visualize and determine distances of remote objects in the field using appropriate sonar signals to characterize environments obscured by fire, smoke, dust, fog, or other particles that may diminish visibility.

Other embodiments may be employed in a form that can be worn by the user or operate in conjunction with systems used or worn by the user. For example, particular embodiments may be incorporated within or used in conjunction with appropriate headgear, eyewear, or clothing. In some embodiments, appropriate navigation information, including but not limited to information determined according to the teachings of the present disclosure, may be communicated electronically to other systems used or worn by the user such as suitable headgear, eyewear, or clothing, or to remote systems such as a centralized incident command center.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

Embodiments of the present disclosure may be better understood through reference to the following figures in which:

FIG. 1 is a block diagram illustrating an example handheld navigation system for navigating a high temperature environment.

FIG. 2 illustrates an example process flow for determining approximate distance of remote objects in a high temperature environment.

FIG. 3 is an example high temperature environment for detecting the location of a remote wall in a high temperature environment.

FIG. 4 is a color plot of example results from using a handheld navigation system of the present disclosure in a high temperature environment with a seven kilowatt fire in a room with a remote wall.

FIG. 5 is a color plot of example results from using the handheld navigation system of the present disclosure in a high temperature environment with a forty-three kilowatt fire in a room with a remote wall.

FIG. 6 is an example high temperature environment for detecting the location of a remote doorway in a high temperature environment.

FIG. 7 is a color plot of example results obtained using the handheld navigation system of the present disclosure in a high temperature environment with a forty-three kilowatt fire in a room with remote walls forming a doorway.

### DETAILED DESCRIPTION

The present disclosure may be better understood through reference to the following examples. These examples are included to describe exemplary embodiments only and should not be interpreted to encompass the entire breadth of the present disclosure.

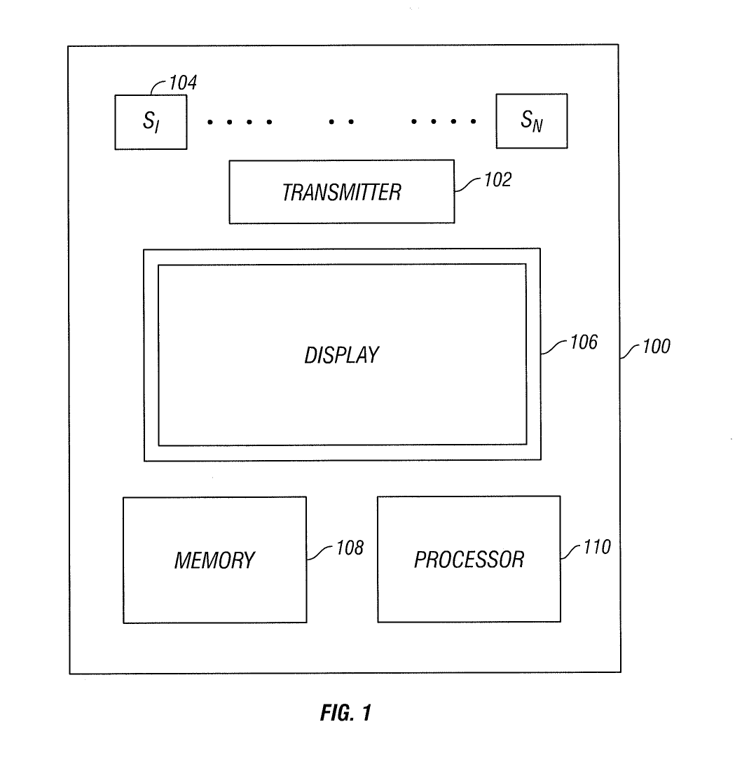

FIG. 1 is a block diagram illustrating an example handheld navigation system for navigating an obscured, high temperature environment. As illustrated, an example embodiment of a handheld navigation system 100 is shown which has elements that interoperate to facilitate navigation in high temperature low visibility environments. The elements of system 100 can provide navigational support to various stakeholders including firefighters, military personnel, and rescue crews. In particular embodiments, system 100 may allow user to determine the distance of a remote object in environments such as a smoke-filled room or a room engulfed with flames, or other high temperature low visibility environments. For example, certain embodiments of system 100 may determine distances to remote objects located within a burning structure, such as a wall or doorway, thereby enabling users of the handheld device to navigate the dangerous environment. In particular implementations, the teachings of the present disclosure may be combined with video cameras, infrared cameras, or other suitable navigation tools to enhance a user's awareness of the obscured, high temperature environment and safely maneuver the situation.

As illustrated, handheld navigation system 100 includes a number of components for determining and displaying approximate distance information regarding remote objects or structures. Handheld navigation system 100 may represent any suitable portable hardware, including appropriate controlling logic and data capable of receiving user input, determining an approximate distance to remote object in a low visibility environment and displaying an appropriate image depicting the distance of the remote object. For example, handheld navigation system 100 may be a standalone embedded system or included as an application on larger system providing other additional functionality. In certain implementations, the features and functionality of handheld navigation system 100 may be embodied in a smartphone, such as an APPLE iPHONE or suitable ANDROID smartphone device, or on an appropriate handheld computing device such as a tablet computer. As shown, handheld device 100 includes several components, which may include a transmitter 102, an array of sensors 104, a display 106, a memory 108 and a processor 110.

Transmitter 102 represents any combination of hardware and controlling logic for generating sonar signals of low frequency. For example, transmitter 102 may, in certain embodiments, be a speaker for generating low frequency sounds. In certain embodiments, the frequencies transmitted by transmitter 102 may range from approximately one hundred hertz (Hz) to approximately thirty kilohertz (kHz). The transmitter 102 may also be capable of transmitting a low frequency frequency-modulated signal into an obscured, high temperature environment for a long duration that may range between one tenth of a second to half a second. In other embodiments, transmitter 102 may represent a series of transmitters capable of sending multiple low frequency signals. For example, transmitter 102 may be a parametric array transmitter. In particular embodiments, the transmitter is capable of transmitting a linear frequency modulated signal. Thus, transmitter 102 allows the user to transmit suitable low frequency sonar signals into an obscured, high temperature environment for determining the approximate distance of remote objects.

Array of sensors 104 represents any combination of hardware and controlling logic for detecting reflections of low frequency signals in an obscured, high temperature environment. In certain embodiments, sensors 104 may be a series of microphones. For example, particular implementations may employ a series of shotgun microphones arranged to capture sonar signals arriving from multiple angles. Particular embodiments may use the information gathered by the array of sensors 104 to electronically steer or beamform, such that interference is minimized and resolution of the data calculated by the system is increased. Sensors 104 are capable of converting low frequency sonar signals into digital data for use by other elements of system 100, such as storage by memory 108 and further processing by processor 110. In other embodiments, sensors 104 may include a series of microphones of various types for capturing different types of reflections. In particular implementations, the array of sensors 104 are capable of sensing reflections of low frequency sonar signals from remote objects, converting those signals into digital data, and facilitating processing by other elements of system 100. Although the illustrated system depicts an array of sensors, embodiments of the present disclosure may use a single sensor or any suitable number of sensors, whether disposed in array or at select positions within or around handheld navigation system 100.

Display 106 represents any appropriate combination of hardware, control logic and data for displaying information to a user. In certain embodiments, display 106 may also receive input from the user, thus display 106 may include any suitable input and/or output interface. For example, a user interface may be a suitable touch screen interface that is capable of both displaying graphical information and receiving user input. In other embodiments, display 106 only displays information to the user and does not receive input. In those embodiments, input from the user may be provided by other buttons, a keypad, trackball, track pad, touch screen, or other appropriate actuatable switches provided by handheld navigation system 100. Display 106 may be employed to display an image of the environment that includes the approximate distance information of a remote object calculated by components of handheld navigation system 100. In other embodiments, display 106 may specify the approximate distance of the remote object in numerical form, plotted on a Cartesian coordinate system, or provided in other suitable form.

Memory 108 represents appropriate hardware and control logic for maintaining a sonar processing application and digital sonar data corresponding to transmitted sonar signals or reflections of transmitted sonar signals. The sonar processing application may include the appropriate computer instructions to implement some or all of the features of the present disclosure. Memory 108 may also include storage for other data such as an operating system of system 100. In particular embodiments, memory 108 may include a non-volatile portion and a volatile portion. Non-volatile portion of memory 108 may represent memory for maintaining persistent applications and/or data. The volatile portion of memory 108 represents storage for maintaining non-persistent applications and/or data. Thus, memory 108 may be used to maintain persistent data and non-persistent data corresponding to features of the present disclosure. For example, memory 108 may be employed to store digital representations of the transmitted low frequency sonar signal and/or store digital representations of the reflected low frequency sonar signals. In certain embodiments, memory 108 may be used to store intermediate results of any pertinent calculations performed by processor 110.

In particular embodiments, handheld navigation system 100 is capable of transmitting low frequency sonar signals in an obscured, high temperature environment, receiving reflections of those low frequency signals, and determining the approximate distance of a remote object located in the obscured, high temperature environment based on a calculated correlation of the received reflections to the transmitted low frequency sonar signals. In addition, handheld navigation system 100 may display information regarding the approximate distance to the user or the handheld navigation system 100. For example, handheld navigation system 100 may display the distance of a remote object graphically on a visual image of the obscured, high temperature environment. In other embodiments, handheld navigation system 100 may display a numerical value or plotted value on a Cartesian coordinate system corresponding to the approximate distance of the remote object. In other embodiments, handheld navigation system 100 may display a graphical representation of distance as an overlay upon an infrared or video image of the obscured, high temperature environment. The visual image may be a video image, an infrared image, or other suitable image provided by an appropriate camera. Thus, a handheld device, such as handheld navigation system 100, enables a user to safely navigate low visibility, high temperature environments efficiently and reduce thereby reduce the likelihood of bodily injury or death in such dangerous environments.

In operation, elements of handheld navigation system 100 perform various functions including enabling user input, transmitting low frequency sonar signals in an obscured high temperature environment, detecting reflections of those signals, calculating the cross correlation between the reflected signals and the transmitted low frequency signals, and determining the approximate distance of a remote object. The distance determination may be displayed to the user as a graphical image or a value corresponding to the distance of the remote object. Thus, elements of handheld navigation system 100 can increase the likelihood that users are able to safely navigate a fireground or other high temperature low visibility environments efficiently.

For example, elements of system 100 are operable to determine distances of various objects using low frequency sonar signals. In particular, in response to user input, processor 110 may cause a sonar processing application residing in memory 108 to execute appropriate logic in order to control transmitter 102. Transmitter 102 may be controlled and instructed to send a low frequency, frequency modulated signal in an obscured, high temperature environment. In particular embodiments, the transmitted signal may be a linear frequency modulated signal. The processor 110 may also execute appropriate instructions of the sonar processing application residing in memory 108 to cause the array of sensors 104 to collect reflections of the transmitted signal from the environment. In response to collecting the reflections of the low frequency, frequency modulated signal, system 100 may store the collected data in memory 108 using processor 110. Processor 110 of system 100 may then proceed to determine the cross correlation between the reflected signals and the transmitted signals in order to determine when the cross correlation is the highest. Next, applying the appropriate speed of sound for the obscured, high temperature environment, system 100 may cause processor 110 to determine the appropriate distance to the remote object. The speed of sound may vary depending on the temperature of the temperature of the environment. For example, the high temperature of the environment may cause sound signals to travel at a higher speed than at normal room temperature, holding all other factors such as air pressure and humidity constant. Some embodiments may take into account information retrieved from one or more sensors to determine the appropriate speed of sound. For example, appropriate sensors may provide information that may have an effect on the appropriate speed of sound in a given environment, such as temperature, humidity, air pressure, and/or other environmental conditions. In other embodiments, system 100 may use the speed of sound at room temperature under normal conditions or typical conditions for the type of obscured, high temperature environment. Next, handheld navigation system 100 may display the resulting calculated approximate distance using display 106, either in numerical form or in an appropriate graphical form. For example, in certain embodiments, display 106 may display an infrared image from an infrared camera and the distance information may be presented as an overlay on a video or infrared image. Other embodiments may plot the distance information on a Cartesian coordinate system or other suitable coordinate system. Thus, a user of handheld navigation system 100 may determine distances in real time in order to be able to safely navigate a fireground, a smoky environment or other high temperature, low visibility environments.

While system 100 is illustrated as including specific components, it should be understood that various embodiments may operate using any suitable arrangement and collection of components. For example, system 100 may be employed as a standalone system, collection of systems, or embodied as an application in a system capable of providing numerous other features. In particular embodiments, a sonar system may be combined with a thermal imaging camera system. Other embodiments may also use sonar signals to obtain an image of the active fire flame. Certain embodiments may include suitable environmental and/or atmospheric sensors (e.g., thermometers, bolometers, barometers, and/or water vapor sensors) in order to determine the evolution of the obscured, high temperature environment over time. Such embodiments may facilitate higher resolution distance calculations based on adjustments to the speed of sound given varying environmental conditions. Other embodiments may be employed in mobile platforms, such as mobile search and rescue robots used to assist fire fighters. Particular embodiments may be used by military personnel to visualize and determine distances of remote objects in the field using appropriate sonar signals to characterize environments obscured by fire, smoke, dust, fog, or other particles that may diminish visibility.

Particular embodiments may use suitable sensors of position or movement, such as accelerometers and/or gyroscopes, to measure, calculate, store, and display information regarding position, speed, orientation, angle, or other appropriate information. For example, the teachings of the present disclosure may be combined with systems capable of determining positions in a three-dimensional space, angle of orientation, heading, elevation, and bank (e.g., yaw, pitch, and/or roll). Such additional information may enable a suitable system to provide a user with a comprehensive image of the obscured, high temperature environment as it may change over time and in relation to movement of the system or the user. This additional information may also facilitate determining the location of the flame of an active fire with higher resolution, and further determine how the flame changes over time.

Other embodiments may be employed in a form that can be worn by the user or operate in conjunction with systems used or worn by the user. For example, particular embodiments may be incorporated within or used in conjunction with appropriate headgear, eyewear, or clothing. In some embodiments, appropriate navigation information, including but not limited to information determined according to the teachings of the present disclosure, may be communicated electronically to other systems used or worn by the user such as suitable headgear, eyewear, or clothing, or to remote systems such as a centralized incident command center.

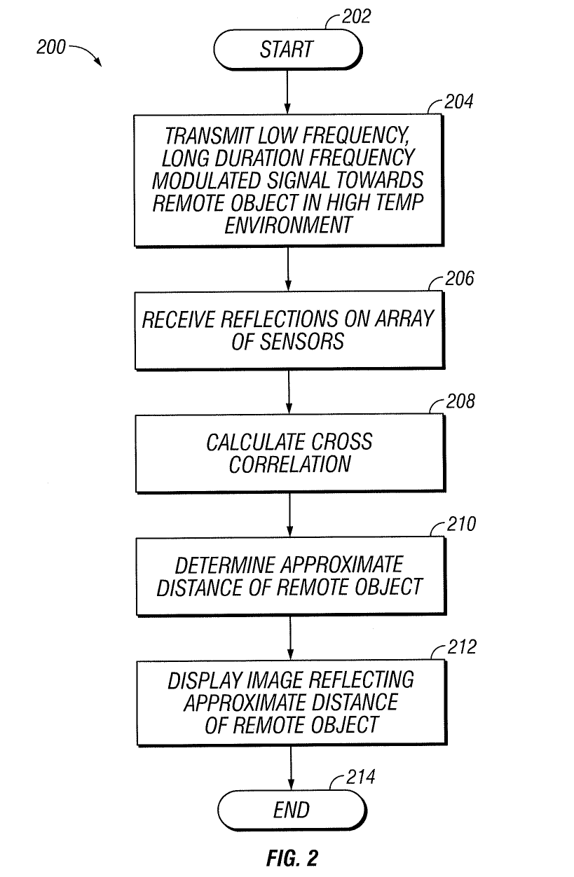

FIG. 2 is a process flow diagram illustrating a process flow 200 for determining an approximate distance to a remote object in a high temperature, low visibility environment. The steps of process flow 200 correspond to an example sequence of steps for navigating high temperature environments such as structures engulfed with flames, smoky environments, a war zone or other high temperature situations characterized by low visibility, for example, due to aerosol particles (e.g., smoke, dust, sand). Such a process of determining the approximate distance of remote objects enables individuals, such as firefighters or military personnel, to be able to navigate difficult and dangerous circumstances posed by fire, smoke or other high temperature elements or aerosol particles. A process like process flow 200 may be implemented on a handheld navigation system such as system 100, which provides an interface to the user to provide input and receive output related to the distance calculations ascertained by the system.

In the illustration, process flow 200 includes a number of steps for transmitting and collecting information about low frequency signals in the obscured, high temperature environment, performing a number of calculations. and determining the approximate distance of remote objects in the area. This information can be displayed in a suitable form at the end of process flow 200. As illustrated, system 200 begins at step 202 and ends at step 214. The steps of system 200 include transmission step 204, reception step 206, correlation step 208, distance calculation step 210 and displaying step 212. This collection of steps may be performed, for example, on a handheld navigation system, such as handheld navigation system 100, through an appropriate user interface for interacting with the device.

In operation, process flow 200 begins at step 202. The first step in the process of process flow 200 is at transmission step 204. At transmission step 204, the system transmits a low frequency, long duration, frequency modulated signal towards a remote object in an obscured, high temperature environment. In particular embodiments, the transmitted signal may be a linear frequency modulated signal. In this step, a sonar signal may be transmitted towards areas of interest within an environment, the use of low frequency and long duration signal facilitates the accurate collection of reflections of those signals with little interference due to smoke, flames, or temperature. In obscured, high temperature environments such as those including active fires, the use of long duration low frequency signals eliminates any inaccuracies that may result from the effects an unpredictable flame may have on higher frequency signals. In certain embodiments, using a long duration low frequency signal may average out the effects of a high frequency flame. In particular embodiments, the duration of the low frequency signal may range between one tenth of second and half a second and the frequencies of the transmitted signal may range between one hundred hertz and thirty kilohertz. The signal may be transmitted by an appropriate speaker, such as a tweeter speaker or other suitable low frequency transmitter. In certain embodiments, the low frequency long duration signal is transmitted as a frequency modulated signal spanning a range of appropriate low frequencies. For example, the transmitted signal may be a linear frequency modulated signal.

Next, the handheld device proceeds to reception step 206 where reflections of the transmitted frequency modulated signal are received on an array of sensors. In particular embodiments, the sensors may be a series of microphones. For example, the sensors may be a series of shotgun microphones capable of collecting reflections from various angles of the room. Process flow 200 then enters cross correlation step 208 where the processor of the handheld navigation system calculates the cross correlation between the reflections received on the array of sensors and the transmitted frequency modulated signal. Using the cross correlation values and the speed of sound corresponding the high temperature environment, the handheld navigation system may perform a distance calculation in distance calculation step 210. The speed of sound may vary according to the temperature of the obscured, high temperature environment which may be sensed using an appropriate temperature sensor on the handheld navigation device. This information may be used in distance determination step 210 in order to determine a more accurate distance of the remote object of interest. In other embodiments, the speeds of sound at room temperature under normal conditions, or an approximation of the temperature in the environment may be employed to determine the approximate distance of the remote object. In some embodiments, the approximate temperature of the environment may be provided by the user. In other embodiments, more accurate temperature values may be obtained using other sensor systems, such as a thermometer or a radiation sensing bolometer. Finally, in step 212, an image reflecting the approximate distance to the remote object may be displayed. In particular embodiments, this may involve overlaying the distance information on a previously collected or simultaneously collected video or infrared image of the obscured, high temperature environment. In other embodiments, the distance information may be displayed as a numerical value or other suitable coordinate scale such that the user can determine the relative location of specific structures within the user's environment. In particular embodiments, process flow 200 enables the user to safely navigate the obscured, high temperature environment efficiently, and thereby minimize bodily injury or death. Process flow 200 ends at step 214.

While process flow 200 is illustrated as including specific steps, it should be understood that various embodiments may implement a distance determination scheme for navigating an obscured, high temperature environment using any appropriate combination of steps for providing access to distance information regarding remote objects. For example, process flow 200 may be modified or combined with separate processes provided by other suitable navigation tools, such as video cameras and infrared cameras, to enhance the user's ability to quickly and safely navigate high temperature low visibility environments. As another example, process flow 200 may be modified to receive acoustic signals generated by an alarm device located in the high temperature environment or worn by an individual or robot in the high temperature environment. In such embodiments, acoustic signals can be cross correlated to determine the approximate distance of the source of the alarm device, and an image reflecting the approximate distance of the source of the alarm device can be optionally displayed on a handheld device. In these embodiments, any suitable device may be used including but not limited to a personal alert safety system carried by firefighters. Such embodiments may be used to locate a downed fighfighter, robot, or to identify particular locations of interest in a high temperature environment.

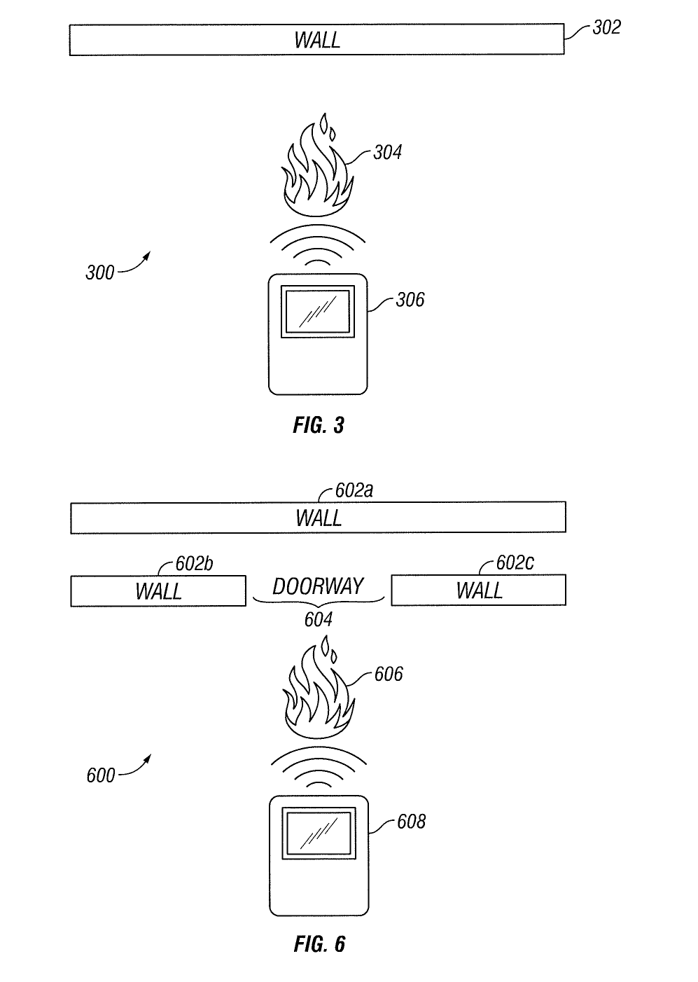

FIG. 3 illustrates an example obscured, high temperature environment that includes a wall at a remote location. As shown in system 300, a high temperature environment includes a wall 302, a fire 304, and a handheld navigation system 306. Wall 302 represents the distant wall forming the far boundary of an open room. As illustrated in obscured, high temperature environment 300, fire 304 may be located near the middle of the room. In particular embodiments the fire may be of various power ratings. For example, in one particular embodiment, the fire may be a seven kilowatt fire, and in another embodiment, the fire may be a 43 kilowatt fire. While some figures illustrate specific fire power ratings, it should be understood that the teachings of the present disclosure can be used with fires of any power rating.

Handheld navigation system 306 may represent a handheld device according to the present disclosure, such as described in system 100. In operation, handheld navigation system 306 may transmit low frequency, long duration, frequency modulated signals towards wall 302. For example, the transmitted signal may be a linear frequency modulated signal. In particular embodiments, the signal may be transmitted through the flames or smoke generated by fire 304. The low frequency and long duration of the transmitted signals ensure that little or no interference occurs due to the high frequency turbulence that may be caused by the burning flames of an active fire 304. In particular circumstances, the flames of fire 304 may be unpredictable and can change rapidly. However, the use of low frequency long duration signals facilitates transmission through fire 304 to wall 302, with little or no artifacts resulting in the transmitted signals or the corresponding reflected signals. Handheld navigation system 306 may then collect reflections of the transmitted signal from wall 302, whether using a path directly through flame 304 or otherwise, and cross correlate this information to the transmitted signal in order to determine an approximate location of the remote wall 302. This information may then be displayed on the display of handheld navigation system 306 in a suitable format intelligible to the user. In other embodiments, handheld navigation system 306 may transmit sonar signals sweeping a range of frequencies that include both high and low frequencies. In those embodiments, the information from the reflected signals of both high and low frequencies may be used to determine, with higher precision, the characteristics of structures and the active flame.

While system 300 is illustrated as including specific components, it should be understood that various embodiments may operate using any suitable arrangement and collection of components.

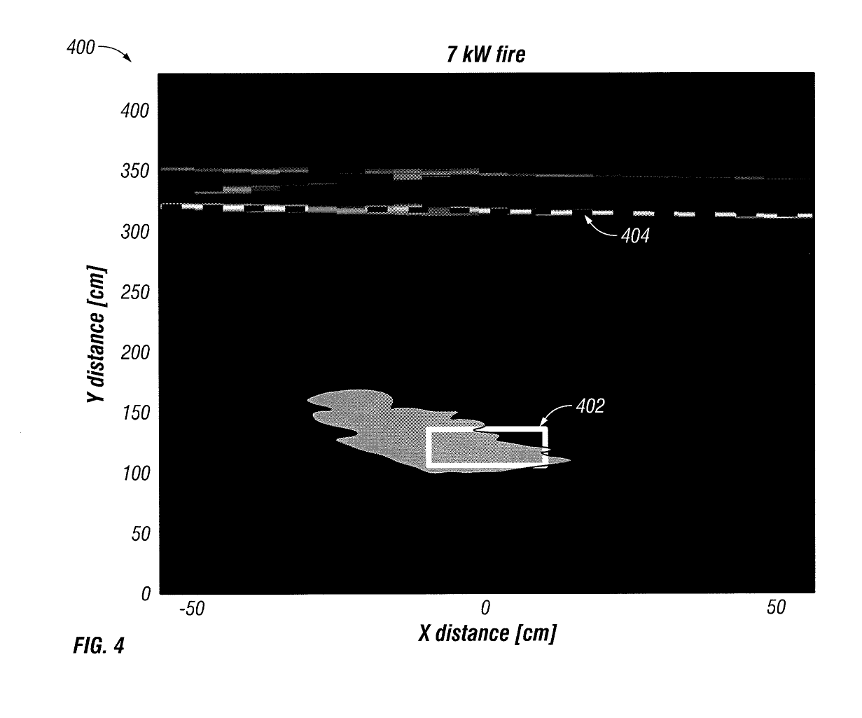

FIG. 4 represents a color plot on a Cartesian coordinate system mapping distance in the Y-direction across the Y-axis and distance in the X-direction across the X-axis in an two-dimensional Cartesian coordinate system where (0, 0) represents the center of the room. As shown, system 400 depicts the obscured, high temperature environment of system 300 as characterized by a seven kilowatt fire and includes the calculated distance information determined on an appropriate handheld navigation system according to the techniques of the present disclosure. For example, system 400 includes an image of the fire 402 and the image of the remote wall 404. As shown in system 400, the image of fire 402 corresponds to the fire 304 in system 300, and the image of the wall 404 corresponds to the wall 302 of the example obscured, high temperature environment in system 300.

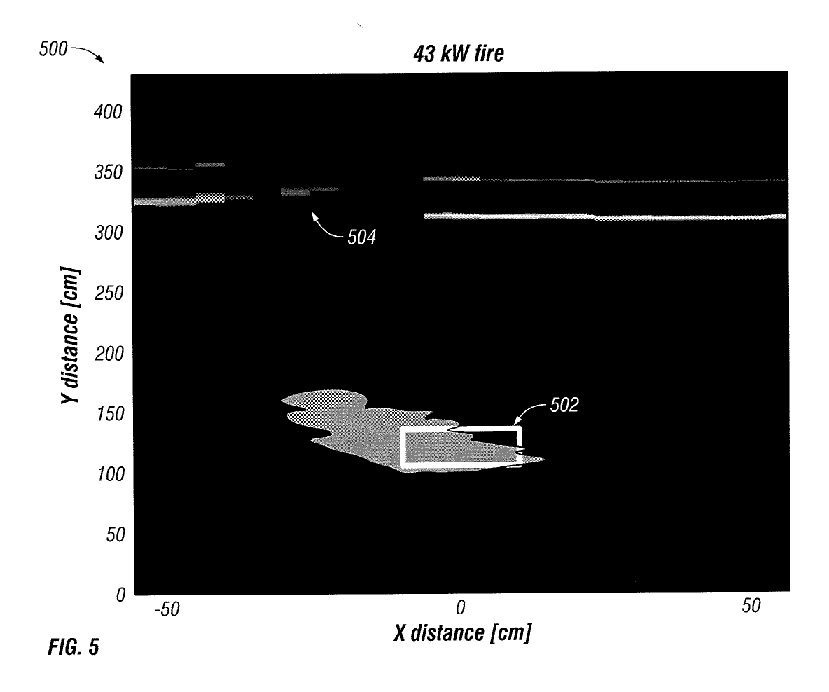

FIG. 5 represents a color plot on a Cartesian coordinate system mapping distance in the Y-direction across the Y-axis and distance in the X-direction across the X-axis in an two-dimensional Cartesian coordinate system where (0, 0) represents the center of the room. As shown, system 500 depicts the obscured, high temperature environment of system 300 characterized by a forty three kilowatt fire and includes the calculated distance information determined on an appropriate handheld navigation system according to the techniques of the present disclosure. For example, system 500 includes an image of the fire 502 and the image of the remote wall 404. As shown in system 500, the image of fire 502 corresponds to the fire 304 in system 300, and the image of the wall 504 corresponds to the wall 302 of the example obscured, high temperature environment in system 300.

While systems 300 and 400 are depicted as illustrating specific features of an obscured, high temperature environment, it should be understood that various embodiments may provide less or additional information regarding the obscured, high temperature environment using any suitable arrangement and collection of components.

FIG. 6 is an example obscured, high temperature environment for detecting the location of a remote doorway in the obscured high temperature environment. As illustrated, an example obscured, high temperature environment is shown that includes a wall at a remote location. As shown in system 600, the obscured, high temperature environment includes walls 602, a doorway 604, a fire 606, and a handheld navigation system 608. Walls 602 represent distant walls together forming a remote doorway 604 in between wall 602 b and 602c. As illustrated in obscured, high temperature environment 600, fire 606 may be located near the middle of the room. In particular embodiments the fire may be of various power ratings, for example, in one particular embodiment, the fire may be a seven kilowatt fire and in another embodiment, the fire may be a 43 kilowatt fire.

Handheld navigation system 608 may represent a handheld device according to the present disclosure, such as described in system 100. In operation, handheld navigation system 608 may transmit low frequency, long duration, frequency modulated signals towards walls 602. For example, the transmitted signal may be a linear frequency modulated signal. In particular embodiments, the signal may be transmitted through the flames or smoke generated by fire 606. The low frequency and long duration of the transmitted signals ensure that little or no interference occurs due to the high frequency turbulence that may be caused by the burning flames of an active fire 606. In particular circumstances, the flames of fire 606 may be unpredictable and can change rapidly. However, the use of low frequency long duration signals facilitates transmission through fire 606 to walls 602, with little or no artifacts resulting in the transmitted signals or corresponding reflected signals. Handheld navigation system 608 may collect the reflections of the transmitted signal from walls 602, whether using a path directly through flame 606 or otherwise, and cross correlate this information to the transmitted signal in order to determine an approximate location of each of the remote walls 602. The determined distance and location of walls 602a, 602b, and 602c enables the handheld navigation to determine the presence and location of a doorway between walls 602b and 602c. The distance information may then be displayed on the display of handheld navigation system 608 in a suitable format intelligible to the user such that the presence and location of doorway 604 can be determined by the user despite the high temperature and low visibility presented by the extreme conditions of the environment. Such information may enable the user to determine the various structures in the room and appropriate exit paths, thereby facilitating safe and efficient navigation in the dangerous environment.

While system 600 is illustrated as including specific components, it should be understood that various embodiments may operate using any suitable arrangement and collection of components.

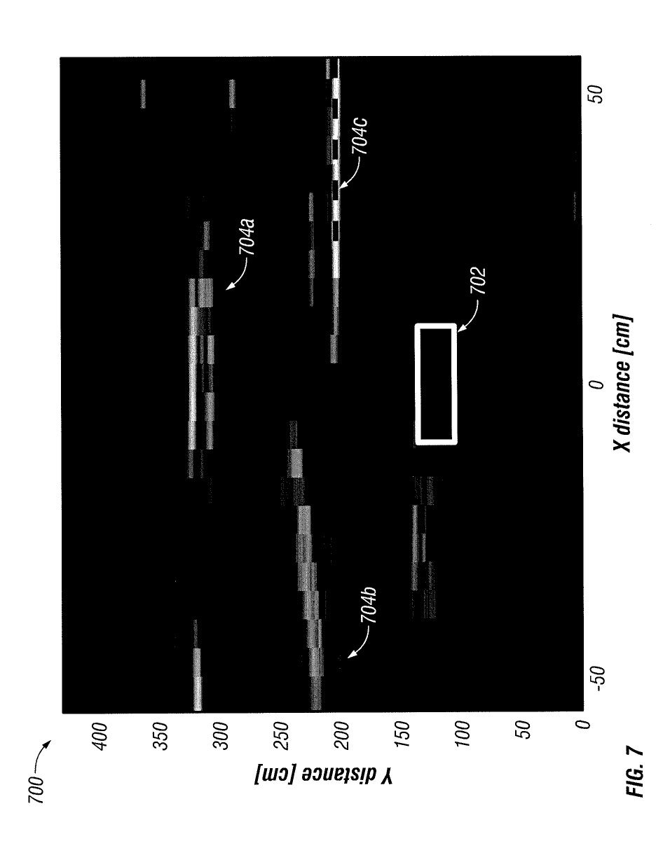

FIG. 7 illustrates a color plot of example results from using the handheld navigation system of the present disclosure in an obscured, high temperature environment having a forty-three kilowatt fire in a room with remote walls forming a doorway. As illustrated, system 700 represents a color plot on a Cartesian coordinate system mapping distance in the Y-direction across the Y-axis and distance in the X-direction across the X-axis in an two-dimensional Cartesian coordinate system where (0, 0) represents the present position of the handheld navigation system depicted in system 600. As shown, system 700 depicts the obscured, high temperature environment of system 600 characterized by a forty three kilowatt fire and includes the calculated distance information determined on an appropriate handheld navigation system according to the techniques of the present disclosure. For example, system 700 includes an image of the fire 702 and the image of the remote walls 704. As shown in system 700, the image of fire 702 corresponds to the fire 606 in system 600, and the images of the walls 704 correspond to the walls 602 of the example obscured, high temperature environment in system 600. The image of the remote walls 704b and 704c together form the boundaries of the doorway that exists between them. In this manner, a user may determine the appropriate exits in a structure despite high temperatures and low visibility.

While system 700 is depicted as illustrating specific features of an obscured, high temperature environment, it should be understood that various embodiments may provide less or additional information regarding the obscured, high temperature environment using any suitable arrangement and collection of components. Although only exemplary embodiments of the invention are specifically described above, it will be appreciated that modifications and variations of these examples are possible without departing from the spirit and intended scope of the invention. For example, throughout the specification particular measurements are given. It would be understood by one of ordinary skill in the art that in many instances, particularly outside of the examples, other values similar to, but not exactly the same as the given measurements may be equivalent and may also be encompassed by the present disclosure.

What is claimed is:

1. A handheld navigation apparatus comprising:
a display;
a memory for maintaining a sonar processing application;
a transmitter capable of transmitting low frequency sonar signals;
an array of sensors capable of detecting low frequency sonar signals;
a processor operable when executing the sonar processing application to:
cause the transmitter to transmit a frequency modulated sonar signal of long duration toward a remote object located in an obscured high temperature environment;
cause the array of sensors to receive spatially diverse reflections of the frequency modulated sonar signal;
calculate a cross correlation the received reflections of the frequency modulated sonar signal to the transmitted frequency modulated sonar signal;
determine the approximate distance of the remote object located in the obscured high temperature environment based on the calculated cross correlation; and
display an image on the display depicting the approximate distance of the remote object.

2. The apparatus of claim 1, wherein the frequency modulated signal comprises frequencies greater than approximately 100 hertz and less than approximately 30 kilohertz.

3. The apparatus of claim 1, wherein the duration of the frequency modulated signal is at least about one tenth of a second.

4. The apparatus of claim 1, wherein determining the approximate distance of the remote object is further based on a sensed temperature of the obscured high temperature environment.

5. The apparatus of claim 1, further comprising an infrared camera operable to determine the relative thermal intensity of regions of the obscured high temperature environment.

6. The apparatus of claim 5, wherein displaying the image on the display comprises depicting the approximate distance of the remote object on a thermal image of the relative thermal intensity of regions of the obscured high temperature environment.

7. The apparatus of claim 1, wherein the array of sensors comprises an array of shotgun microphones.

8. A method comprising:
transmitting, using a low frequency transmitter, a frequency modulated sonar signal of long duration toward a remote object located in an obscured high temperature environment;
receiving, at an array of sensors, spatially diverse reflections of the frequency modulated sonar signal;
calculating, using a processor, a cross correlation the received reflections of the frequency modulated sonar signal to the transmitted frequency modulated sonar signal;
determining the approximate distance of the remote object located in the obscured high temperature environment based on the calculated cross correlation; and
displaying an image on the display depicting the approximate distance of the remote object.

9. The method of claim 8, wherein the frequency modulated signal comprises frequencies greater than approximately 100 hertz and less than approximately 30 kilohertz.

10. The method of claim 8, wherein the duration of the frequency modulated signal is at least about one tenth of a second.

11. The method of claim 8, wherein determining the approximate distance of the remote object is further based on a sensed temperature of the obscured high temperature environment.

12. The method of claim 8, further comprising determining, using an infrared camera, the relative thermal intensity of regions of the obscured high temperature environment.

13. The method of claim 12, wherein displaying the image on the display comprises depicting the approximate distance of the remote object on a thermal image of the relative thermal intensity of regions of the obscured high temperature environment.

14. The method of claim 8, wherein the array of sensors comprises an array of shotgun microphones.

15. A non-transitory computer readable medium comprising instructions, the instructions operable when executed by a processor to:
transmit, using a low frequency transmitter, a frequency modulated sonar signal of long duration toward a remote object located in an obscured high temperature environment;
receive, at an array of sensors, spatially diverse reflections of the frequency modulated sonar signal;
calculate a cross correlation the received reflections of the frequency modulated sonar signal to the transmitted frequency modulated sonar signal;
determine the approximate distance of the remote object located in the obscured high temperature environment based on the calculated cross correlation; and
display an image on the display depicting the approximate distance of the remote object.

16. The non-transitory computer readable medium of claim 15, wherein the frequency modulated signal comprises frequencies greater than approximately 100 hertz and less than approximately 30 kilohertz.

17. The non-transitory computer readable medium of claim 15, wherein the duration of the frequency modulated signal is at least about one tenth of a second.

18. The non-transitory computer readable medium of claim 15, wherein the processor is further operable when executing the sonar processing application to determine the approximate distance based on a temperature of the obscured high temperature environment.

19. The non-transitory computer readable medium of claim 15, wherein displaying the image on the display comprises depicting the approximate distance of the remote object on a thermal image of the relative thermal intensity of regions of the obscured high temperature environment, the thermal image determined using an infrared camera.

20. The non-transitory computer readable medium of claim 15, wherein the array of sensors comprises an array of shotgun microphones.
